(19) United States
(12) Patent Application Publication
(10) Pub. No.: US 2025/0214574 A1
(43) Pub. Date: Jul. 3, 2025

(54) VEHICLE FOR PERFORMING MINIMAL RISK MANEUVER AND METHOD OF OPERATING THE SAME

(71) Applicants: Hyundai Motor Company, Seoul (KR); Kia Corporation, Seoul (KR); Ajou University Industry-Academic Cooperation Foundation, Suwon-si (KR)

(72) Inventors: Jong Sung Park, Hwaseong-Si (KR); Young Bin Min, Hwaseong-Si (KR); Bong Sob Song, Suwon-Si (KR)

(21) Appl. No.: 19/001,929

(22) Filed: Dec. 26, 2024

(30) Foreign Application Priority Data
Dec. 29, 2023 (KR) 10-2023-0196677
Oct. 18, 2024 (KR) 10-2024-0142791

(51) Int. Cl. B60W 30/09; B60W 10/18; B60W 30/095; G06N 3/092

(52) U.S. Cl. CPC B60W 30/09; B60W 10/18; B60W 30/0956; G06N 3/092; B60W 2552/30; B60W 2554/801; B60W 2554/802

(57) ABSTRACT

A vehicle for performing a minimal risk maneuver is disclosed. The vehicle may include at least one sensor configured to detect a surrounding environment of the vehicle; a controller configured to control an operation of the vehicle; and a processor coupled to the at least one sensor and the controller. The processor may be configured to: identify vehicle state information of the vehicle; identify, based on the detected surrounding environment, surrounding environment information associated with the vehicle; determine, based on the vehicle state information or the surrounding environment information, whether autonomous driving is possible for the vehicle; and perform, based on the autonomous driving not being possible, a minimal risk maneuver (MRM). Performing the MRM may include applying, based on a predicted trajectory of the vehicle satisfying a predetermined condition while performing the MRM, asymmetric braking forces to left wheels of the vehicle and right wheels of the vehicle.

### CROSS REFERENCE TO RELATED APPLICATION

The present application claims priority to Korea Patent Application No. 10-2023-0196677, filed Dec. 29, 2023, and Korea Patent Application No. 10-2024-0142791, filed Oct. 18, 2024, the entire contents of which are incorporated herein by reference for all purposes.

### FIELD

The present disclosure relates to a vehicle for performing a minimal risk maneuver and a method of operating the same.

### BACKGROUND

Advanced driver-assistance systems (ADAS) include various driving assistance technologies that help make an operation of a vehicle safer and easier. ADAS has multiple sub-categories of technology that provide convenience to drivers. One such technology is called autonomous driving or an automated driving system (ADS).

When the vehicle is performing autonomous drive, an abnormality might occur in the autonomous driving system. If an appropriate response is not made in the event of such an abnormality, the safety of the vehicle and its occupants might be compromised.

### SUMMARY

An object of the present disclosure is to solve disadvantages of at least some implementations, and one or more example embodiments of the present disclosure may provide a vehicle performing a minimal risk maneuver (MRM) to eliminate (or reduce) a risk that is detected when normal autonomous driving is impossible during the autonomous driving, and a method of operating the vehicle.

When a situation is detected during autonomous driving of a vehicle in which normal autonomous driving is impossible, one or more example embodiments of the present disclosure may provide a control method configured to predict dangerous behavior and perform braking when attempts to stop in a straight line through minimal risk operation, and to mitigate or eliminate dangerous behavior by performing asymmetric braking in an event of dangerous behavior.

Aspects according to the present disclosure are not limited to the above ones, and other aspects and advantages that are not mentioned above can be clearly understood from the following description and can be more clearly understood from the example embodiments set forth herein.

According to one or more example embodiments of the present disclosure, a vehicle may include: at least one sensor configured to detect a surrounding environment of the vehicle; a controller configured to control an operation of the vehicle; and a processor coupled to the at least one sensor and the controller. The processor may be configured to: identify vehicle state information of the vehicle; identify, based on the detected surrounding environment, surrounding environment information associated with the vehicle; determine, based on at least one of the vehicle state information or the surrounding environment information, whether autonomous driving is possible for the vehicle; and perform, based on the autonomous driving not being possible, a minimal risk maneuver (MRM). Performing the MRM may include applying, based on a predicted trajectory of the vehicle satisfying a predetermined condition while performing the MRM, asymmetric braking forces to left wheels of the vehicle and right wheels of the vehicle.

The processor may be further configured to: determine that the predicted trajectory of the vehicle satisfies the predetermined condition while performing the MRM, based on the MRM including performance of a straight stop as a type of the MRM and based on the vehicle driving on a curved road.

The processor may be further configured to: determine that the predicted trajectory of the vehicle satisfies the predetermined condition while performing the MRM, based on the MRM including performance of a stop with an amount of lateral control below a threshold value and based on the vehicle driving on a curved road.

The processor may be further configured to: determine that the predicted trajectory of the vehicle satisfies the predetermined condition while performing the MRM, based on the predicted trajectory indicating at least one of: a predicted lane departure, a predicted collision with a guard rail, or a predicted collision with another vehicle.

The processor may be further configured to: determine a longitudinal safety distance by selecting a least value of: a stopping distance, a collision risk distance, and a lane departure distance; determine a lateral safety distance by selecting a lesser value of: a width of an adjacent lane minus a width of another vehicle driving in the adjacent lane, and a maximum intrusion allowance range; and determine, based on the MRM including performance of a straight stop, an MRM buffer zone according to the longitudinal safety distance and the lateral safety distance.

The processor may be further configured to: determine that the predicted trajectory of the vehicle satisfies the predetermined condition while performing the MRM, based on the longitudinal safety distance being less than the stopping distance.

The processor may be configured to apply the asymmetric braking forces by: determining at least one predicted trajectory based on at least one differential braking force; and determining, from among the at least one differential braking force, a differential braking force that allows the vehicle to stop within the MRM buffer zone.

The processor may be further configured to: update, based on the vehicle turning due to the differential braking force, the MRM buffer zone; and determine, based on the updated MRM buffer zone, an updated differential braking force.

The processor may be further configured to: determine the differential braking force by using a reinforced learning artificial intelligence based on driving trajectory information. The driving trajectory information may indicate differential braking forces obtained by a simulation or an empirical test.

The processor may be further configured to: provide, as an input for training the reinforced learning artificial intelligence, information about a velocity of the vehicle, a predetermined MRM buffer zone, and information about a curvature of a current driving lane.

According to one or more example embodiments of the present disclosure, a method performed by an apparatus of a vehicle may include: identifying vehicle state information of the vehicle; identifying, based on a surrounding environment of the vehicle detected by at least one sensor, surrounding environment information associated with the vehicle; determining, based on at least one of the vehicle state information or the surrounding environment information, whether autonomous driving is possible for the vehicle; and performing, based on the autonomous driving not being possible, a minimal risk maneuver (MRM). Performing the MRM may include applying, based on a predicted trajectory of the vehicle satisfying a predetermined condition while performing the MRM, asymmetric braking forces to left wheels of the vehicle and right wheels of the vehicle.

The method may further include: determining that the predicted trajectory of the vehicle satisfies the predetermined condition while performing the MRM, based on the MRM including performance of a straight stop as a type of the MRM and based on the vehicle driving on a curved road.

The method may further include: determining that the predicted trajectory of the vehicle satisfies the predetermined condition while performing the MRM, based on the MRM including performance of a stop with an amount of lateral control below a threshold value and based on the vehicle driving on a curved road.

The method may further include: determining that the predicted trajectory of the vehicle satisfies the predetermined condition while performing the MRM, based on the predicted trajectory indicating at least one of: a predicted lane departure, a predicted collision with a guard rail, or a predicted collision with another vehicle.

The method may further include: determining a longitudinal safety distance by selecting a least value of: a stopping distance, a collision risk distance, and a lane departure distance; determining a lateral safety distance by selecting a lesser value of: a width of an adjacent lane minus a width of another vehicle driving in the adjacent lane, and a maximum intrusion allowance range; and determining, based on the MRM including performance of a straight stop, an MRM buffer zone according to the longitudinal safety distance and the lateral safety distance.

The method may further include: determining that the predicted trajectory of the vehicle satisfies the predetermined condition while performing the MRM, based on the longitudinal safety distance being less than the stopping distance.

Applying the asymmetric braking forces may include: determining at least one predicted trajectory based on at least one differential braking force; and determining, from among the at least one differential braking force, a differential braking force that allows the vehicle to stop within the MRM buffer zone.

The method may further include: updating, based on the vehicle turning due to the differential braking force, the MRM buffer zone; and determining, based on the updated MRM buffer zone, an updated differential braking force.

The method may further include: determining the differential braking force by using a reinforced learning artificial intelligence based on driving trajectory information. The driving trajectory information may indicate differential braking forces obtained by a simulation or an empirical test.

The method may further include: providing, as an input for training the reinforced learning artificial intelligence, information about a velocity of the vehicle, a predetermined MRM buffer zone, and information about a curvature of a current driving lane.

According to the example embodiments of the present disclosure, when a situation is detected in which normal autonomous driving is impossible during autonomous driving, the minimal risk maneuver operation may be performed and vehicle risk may be minimized, thereby improving safety. Especially, when performing the minimal risk maneuver operation, if a dangerous behavior is predicted, additional asymmetric braking may be used, thereby mitigating or eliminating the dangerous behavior.

### BRIEF DESCRIPTION OF THE DRAWINGS

FIG. 1 is a block view of a vehicle;

FIG. 2 is a view showing types of minimal risk operations;

FIG. 3 is a flow chart showing an operation of a vehicle;

FIG. 4 is a flow chart showing that a vehicle stops based on a minimal risk maneuver;

FIGS. 5 and 6 show one example of predicting a minimal risk maneuver allowance space;

FIG. 7 shows one example of eliminating a dangerous behavior situation based on asymmetric braking and stopping a vehicle in an allowance space;

FIG. 8 shows one example of eliminating an allowance space based on asymmetric braking and eliminating a dangerous behavior; and

FIG. 9 shows one example of a reinforced learning-based artificial intelligence that determines a braking force deviation of a vehicle.

### DETAILED DESCRIPTION

Description will now be given in detail according to one or more example embodiments disclosed herein, with reference to the accompanying drawings.

For the sake of brief description with reference to the drawings, the same or equivalent components may be provided with the same reference numbers, and description thereof will not be repeated. For the sake of brief description with reference to the drawings, the same or equivalent components may be provided with the same reference numbers, and description thereof will not be repeated.

Before describing the present disclosure in detail, the terms used therein may be defined as follows.

A vehicle may be equipped with an automated driving system (ADS) for autonomous driving capability. For example, the vehicle may perform at least one of steering, acceleration, deceleration (e.g., braking), lane change, and/or stopping through ADS, with little or no driver manipulation of the vehicle. For example, ADS may include at least one of a pedestrian detection and collision mitigation system (PDCMS), a lane change decision aid System (LCDAS), a lane departure warning system (LDWS), an adaptive cruise control (ACC), a lane keeping assistance system (LKAS), a road boundary departure prevention system (RBDPS), a curve speed warning system (CSWS), a forward vehicle collision warning system (FVCWS), and a low speed following (LSF) system.

A driver may refer to a human using a vehicle equipped with ADS.

Vehicle control authority is the authority for controlling at least one component and/or at least one function of the vehicle. The at least one function of the vehicle, for example, may include at least one of steering, acceleration, deceleration (or braking), lane change, lane detect, lateral control, obstacle recognition and distance detection, powertrain control, safe area detect, engine on/off, power on/off and vehicle lock/unlock functions. The above-mentioned functions are examples to help understanding of example embodiments but the present disclosure is not limited thereto.

A shoulder may refer to the space between the outermost road boundary (or outermost lane boundary) in the direction in which the vehicle is traveling and the road edge (e.g., curb or guardrail). That is, a shoulder is a portion of a roadway provided at the edge of a roadway, which may mean a space where emergency vehicles can stop, where emergency vehicles can bypass traffic jams or where vehicles can leave active traffic jams.

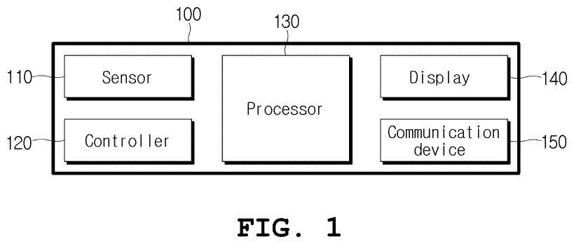

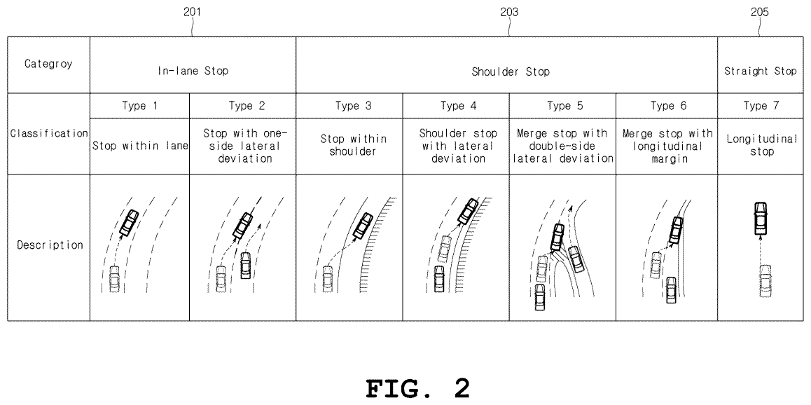

FIG. 1 is a block view of a vehicle. FIG. 2 is a view showing types of minimal risk operations.

In the configuration of the vehicle as shown in FIG. 1, each component may be composed of one chip, one component, one electronic circuit or a combination of chips, components and/or electronic circuits. Some of the components shown in FIG. 1 may be separate multiple components to be configured as different chips, different components or different electronic circuits, and some of them may be combined to be configured as one chip, one component or one electronic circuit. Some of the components shown in FIG. 1 may be omitted or other components not shown in the drawing may be added. At least some of the components shown in FIG. 1 may be described referring to following drawings.

Referring to FIG. 1, a vehicle 100 may include a sensor unit 110, a controller 120, a processor 130, a display 140 and a communication device 150.

The sensor unit 110 may be configured to detect the surrounding environment of the vehicle 100 by using at least one sensor, and generate data related to the surrounding environment based on the detection result.

For example, the sensor unit 110 may obtain information about an object near the vehicle (e.g., another vehicle, a human, a thing, a curb, a guardrail, a lane and an obstacle) based on sensing data obtained by at least one sensor. Information about an object near the vehicle may include at least one of a position, size and shape of an object, a distance to the object and a relative velocity of the object.

As another example, the sensor unit 110 may measure the position of the vehicle 100 by using at least one sensor. For example, the sensor unit 110 may include at least one of a camera, a light detection and ranging (LIDAR), a radio detection and ranging (RADAR), an ultrasonic sensor, an infrared sensor and a position measurement sensor. These sensors are examples, and the sensor of the present disclosure is not limited thereto.

A camera may be configured to capture images of the vehicle's surroundings and generate image data including objects located in front, behind and/or to the side of the vehicle 100. A radar may generate information about objects located in front, behind and/or to the side of the vehicle 100 by using electromagnetic waves (or radio waves). An ultrasonic sensor may generate information about objects located in front, behind and/or to the side of the vehicle 100 by using ultrasonic waves. An infrared sensor may generate information about objects located in front, behind and/or to the side of the vehicle 100 by using infrared waves.

A position measurement sensor may be configured to measure the current position of the vehicle 100. The position measurement sensor may include at least one of a Global Positioning System (GPS) sensor, a Differential Global Positioning System (DGPS) sensor, and a Global Navigation Satellite System (GNSS) sensor. The position measurement sensor may generate position data of the vehicle based on a signal generated by at least one of a GPS sensor, a DGPS sensor and a GNSS sensor.

The controller 120 may be configured to control the operation of at least one component and/or at least one function of the vehicle 100 based on control of the processor 130. For example, the at least one function of the vehicle, for example, may include at least one of steering, acceleration, deceleration (or braking), lane change, lane detect, lateral control, obstacle recognition and distance detection, powertrain control, safe area detect, engine on/off, power on/off and vehicle lock/unlock functions.

For the autonomous driving and/or minimal risk maneuver MRM of the vehicle 100, the controller 120 may be configured to control the operation of at least one component and/or at least one function of the vehicle 100 based on control of the processor 130. For example, for the operation of the minimal risk maneuver, the controller 120 may be configured to control the operation of at least one of steering acceleration, deceleration (or braking), lane change, lane detect, lateral control, obstacle recognition and distance detection, powertrain control, and safe area detect functions.

The processor 130 may be configured to control overall operations of the vehicle 100. The processor 130 may include an electrical control unit ECU configured integrally control the components of the vehicle 100. For example, the processor 130 may include a central processing unit CPU or micro processing unit MCU that may perform computational processing.

The processor 130 may control the components within the vehicle 100 to activate the ADS so that the vehicle can perform autonomous driving, when a specified event occurs. The specified event may occur when the driver's request for the autonomous driving control of the vehicle is recognized, vehicle control authority is delegated from the driver or when conditions predefined by the driver and/or vehicle designer are satisfied.

The processor 130 may determine whether a normal autonomous driving can be performable based on at least one of vehicle state information and surrounding information during the autonomous driving. The processor 130 may monitor mechanical and/or electrical states of components (e.g., sensors, actuators, etc.) inside the vehicle from the time when the ADS is activated, and obtain vehicle state information indicating whether a mechanical defect and/or electrical defect of the components inside the vehicle occurs. The vehicle state information may include information about mechanical states and/or electrical states of the components inside the vehicle. For example, the vehicle state information may include information indicating whether functions required for autonomous driving can operate normal based on the mechanical states and/or electrical states of the components inside the vehicle. The processor 130 may obtain environment information of the vehicle surroundings through the sensor unit 110 from the time when ADS is activated.

The processor 130 may determine whether functions required for autonomous driving can normally operate based on the vehicle state information. The functions required for the autonomous driving may include at least one of a lane detect function, a lane change function, a lateral control function, a deceleration (or brake control) function, a powertrain control function, a safe area detect function, and an obstacle recognition and distance detection function. The processor 130 may determine that a normal autonomous driving is impossible when it is impossible to perform the at least one of the functions required for the autonomous driving.

The processor 130 may determine whether the vehicle state is suitable for a normal driving condition based on the vehicle state information. For example, the processor 130 may determine whether the mechanical state information of the vehicle (e.g., information about battery overheating and tire pressure) is suitable for the normal driving condition. When the vehicle state is not suitable for the normal driving condition, the processor 130 may determine that the normal autonomous driving is impossible.

The processor 130 may determine whether the environment around the vehicle is suitable for Operation Design Domain (ODD) of autonomous driving based on at least one of the surrounding environment information. The processor 130 may determine that normal autonomous driving is impossible, when the surrounding environment information of the vehicle is not suitable for ODD.

When the normal autonomous driving is impossible, the processor may determine that this is a situation requiring performance of minimal risk maneuver MRM for minimizing a risk of an accident. The processor 130 may determine the type of MRM, when it is the situation requiring the performance of MRM.

The processor 130 may also determine that it is the situation requiring the performance of MRM, even when the ADS system is operating normally but an abnormal signal for the driver is detected or an emergency stop is required. The abnormal signal for the driver may include abnormalities in the driver's vital signs or the driver's lack of response to a handover request. The emergency stop may be requested by the driver or a third party (e.g., the police).

Referring to FIG. 2 showing types of the minimal risk maneuver MRM, the types of MRM may include an in-lane stop 201, a shoulder stop 203 and a straight stop 205.

The in-lain stop 201 may include a type of stop-within lane (Type 1) configured to stop the vehicle in a boundary of the lane in which the vehicle was driving; and a type of stop with one-side lateral deviation (Type 2) configured to stop the vehicle while allowing a portion of the vehicle to deviate from the line in one direction.

For example, the type of in-lane stop 201 may mean a type in which the vehicle stops within or partially outside the boundary of the lane in which the vehicle was driving based on the lateral control and/or deceleration.

The type of shoulder stop 203 may include a type of stop within shoulder (Type 3), a type of shoulder stop with lateral deviation (Type 4), a type of merge stop with double-side lateral deviation (Type 5), and a type of merge stop with longitudinal margin (Type 6).

For example, the shoulder stop 203 may mean a type in which the vehicle moves so that a portion or all of the vehicle leaves the road boundary (or the boundary of the outermost lane) and is positioned on the shoulder through the longitudinal acceleration, longitudinal deceleration and/or lateral control, and then stops.

The type of straight stop 205 may include a type of longitudinal stop (Type 7) in which the vehicle drives in a straight line and then stops rather than following the lane.

The straight stop 205 (also referred to as a longitudinal stop or longitudinal braking) is a type in which the vehicle is stopped by using only the longitudinal deceleration function, without any lateral control. For example, the straight stop may be performed in a situation in which the lane detect function is impossible or the lateral control is impossible due to a defect of an actuator for lateral control.

The processor 130 may determine the type of the minimal risk maneuver to be one of the in-lane stop 201, the shoulder stop 203 and the straight stop 205 based on at least one of vehicle state information, external environment information and road traffic laws.

The processor 130 may determine the type of the minimal risk maneuver based on a preset basic type predesignated by the designer, regardless of vehicle state information, external environment and road traffic laws. The predesignated basic type may be the shoulder stop 203. This is because the Road Traffic Act permits (or recommends) stopping a vehicle on the shoulder, which is a relatively safe area in the event of an emergency due to a vehicle breakdown or other cause. Accordingly, the basic type may be predesignated as the shoulder stop 203, so that the possibility of secondary collisions cam be minimized, the impact of the minimal risk maneuver of the vehicle on the traffic flow can also be minimized, and the driver or passengers can be evacuated off the road.

The processor 130 may determine the type of the minimal risk maneuver as the shoulder stop 203 when the ADS system is operated normally but the vehicle state is not suitable for normal driving conditions. For example, the processor 130 may determine the type of the minimal risk maneuver as the shoulder stop 203, when the ADS is normally operating but battery overheating or a tire puncture is detected.

The processor 130 may determine the type of the minimal risk maneuver as the shoulder stop 203, even when an abnormal signal for the driver is detected or an emergency stop is required.

Once determining the type of the minimal risk maneuver as the shoulder stop 203, the processor 130 may control the position of the vehicle to be moved toward the shoulder of the road through the lateral and/or longitudinal control so that at least a portion of the vehicle may be located on the shoulder of the road.

The processor 130 may change the type of the minimal risk maneuver if there is no shoulder area within a specified threshold range where the vehicle can stop based on the current position of the vehicle 100. For example, the processor 130 may change the type of the minimal risk maneuver as the in-lane stop 201 and then perform the in-lane stop.

The processor 130 may determine whether the road shoulder stop is completed within a specified time and determine whether to change the type of the minimal risk maneuver based on the determination result. Unless the road shoulder stop is completed within the specified time, the processor 130 may change the type of the minimal risk maneuver as the in-lane stop 201 from the shoulder stop. For example, when the shoulder stop is not completed within the specified time, the processor 130 may change the type of the minimal risk maneuver as the in-lane stop 201 from the shoulder stop 203, and then control the vehicle to stop in the lane. When the in-lane stop is not completed within a specified time, the processor 130 may change the type of the minimal risk maneuver as the straight stop 205 from the in-lane stop, and then control the straight stop to be performed.

The processor 130 may perform the operation for stopping the vehicle based on the determined type of the minimal risk maneuver, and determine whether a minimal risk condition (MRC) is satisfied. The MCR may mean that the velocity of the vehicle is 0 (zero). For example, the processor 130 may determine whether the vehicle is in a stationary state with a velocity of 0 while performing at least one operation based on the determined type of the minimal risk maneuver. When the vehicle 100 is in the stationary state with the velocity of 0, the processor 130 may determine that the MRC is satisfied.

If the MCR is satisfied, the processor 130 may terminate the minimal risk maneuver and convert the ADS to a standby mode or OFF state. The processor 130 may switch the ADS to the standby mode or OFF state, and then control the control authority for the vehicle to be transferred to the driver (or user).

The display 140 may be configured to display information related to the vehicle visually. For example, the display 140 may provide diverse information related to the state of the vehicle 100 to the driver of the vehicle 100 based on the control of the processor 130. The diverse information related to the state of the vehicle may include at least one of information indicating whether various components of the vehicle and/or at least one function of the vehicle are operating normally, and information indicating the driving state of the vehicle. For example, the driving state of the vehicle may include at least one of a state in which the vehicle is driving autonomously, a state in which the vehicle is performing the minimal risk maneuver, a state in which the minimal risk maneuver is completed, and a state in which the autonomous driving is terminated.

The communication device 150 may communicate with an external device of the vehicle 100. The communication device 150 may be configured to receive data from the outside of the vehicle 100 based on the control of the processor 130 or transmit data to the outside of the vehicle 100. For example, the communication device 150 may perform communication, using a wireless communication protocol or a wired communication protocol.

It is shown in FIG. 1 that the controller 120 and the processor 130 are separated components, but the controller 120 and the processor 130 may be integrally formed as one component.

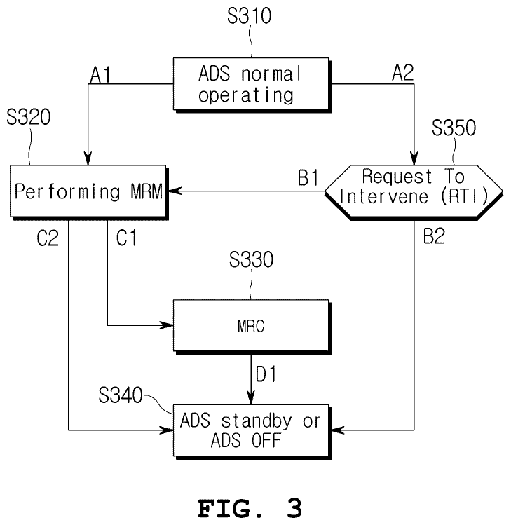

FIG. 3 is a flow chart showing an operation of a vehicle.

Referring to FIG. 3, the vehicle 100 may normally operate the ADS in an operation of S310.

The vehicle 100 may monitor a vehicle state and surrounding environment, while performing the autonomous driving based on the normal operation of the ADS. The vehicle 100 may monitor the vehicle and surrounding environment and detect whether the MRM is needed based on the obtained information. When the MRM is required, an even of A1 may occur.

The vehicle 100 may detect whether the situation requires driver (or user) intervention while performing the ADS based on the normal operation of the ADS. If the driver intervention is required, the vehicle 100 may perform Request To Intervene (RTI) or issue a warning through the ADS. The RTI or warning may be an event of A2. The vehicle 100 may perform an operation of S320 when an event of A1 occurs in the state of the normal operation of the ADS.

When an even of A2 occurs in the normal operation state of the ADS, the vehicle 100 may perform the RTI in an operation of S350 and determine whether the RTI is detected within a specified time. When the RTI is not detected within the specified time, the vehicle 100 may determine that an even of B1 has occurred. When the event of B1 has occurred, the vehicle 100 may perform the operation of S320. When the RTI is detected within a specified time, the vehicle 100 may determine whether an event of B2 has occurred. When the event of B2 has occurred, the vehicle 100 may perform an operation of S340.

The vehicle 100 may perform the MRM in the operation of S320. The vehicle 100 may determine the type of the MRM based on at least one of vehicle state information, surrounding environment information and road traffic laws. The vehicle 100 may determine the type of the MRM as a basic type predesignated by the designer, regardless of the vehicle state information, the external environment information and the road traffic laws. The type of the MRM may be one of the in-lane stop 201, the shoulder stop 203 and the straight stop 205, which are shown in FIG. 2.

The vehicle 100 may control at least one of the components provided therein to stop based on the determined type of the MRM. The vehicle 100 may signal information to other vehicles indicating that the vehicle is performing the MRM.

In an operation of S320, the vehicle 100 may determine whether the minimal risk condition (MRC) is satisfied by performing the MRM, thereby reducing the velocity of the vehicle to 0 (zero). When the MRC is satisfied, the vehicle 100 may determine that an even of C1 has occurred, and perform an operation of S330. The vehicle 100 may determine whether the driver's intervention is detected during the MRM. When the driver intervention is detected, the vehicle 100 may determine that an event of C2 has occurred and perform an operation of S340.

The vehicle 100 may maintain the state in which the MRC is satisfied. The state in which the MRC is satisfied may mean a state in which the vehicle is stationary. For example, the vehicle 100 may maintain the state in which the vehicle is stationary. For example, the vehicle 100 may perform a control operation configured to maintain the stationary state of the vehicle, regardless of the inclination of the road surface at the stopped position. While maintaining the state in which the MRC is satisfied, the vehicle 100 may determine whether an even of D1 occurs. The event of D1 may include at least one of ADS off performed by the driver, and vehicle control authority transfer to the driver. When the event of D1 has occurred, the vehicle 100 may perform an operation of S340.

The vehicle 100 may switch the ADS to a standby mode or OFF state in the operation of S340. The vehicle 100 may not perform the ADS during the standby mode or OFF state.

The operations of S310, S320, S330 and S350 described above are states in which the ADS is activated, and the step of S340 may be a state in which the ADS is deactivated.

Hereinafter, the operation in which the vehicle 100 performs the MRM in S320 will be described in detail. Especially, an operation in which the MRM is performed when the type of the MRM is the straight stop will be described in detail.

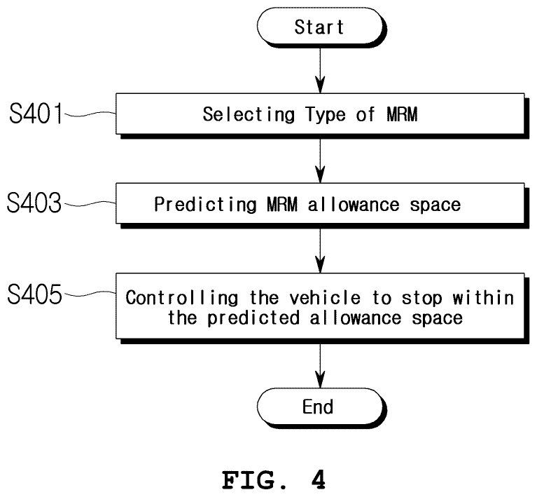

FIG. 4 is a flow chart showing that a vehicle stops based on a minimal risk maneuver.

Operations of FIG. 4 may be specific operations of S320 shown in FIG. 3. Especially, they may be operations of the MRM when the type of the MRM is determined as the straight stop. Each of the operations shown in FIG. 4 may be performed sequentially but not limited to the sequential performance. For example, the order of the operations may be changed and at least two operations may be performed in parallel. In addition, the operations of FIG. 4 may be performed by the processor 130 and/or the controller 120, which are provided in the vehicle 100, or they may be implemented by instructions executable by the processor 130 and/or the controller 120.

The flow chart of FIG. 4 shows that the vehicle stop is performed based on the MRM, but it may be used equally and/or similarly when the vehicle is stationary by the driver's request, even if the situation does not require the MRM.

Referring to FIG. 4, the vehicle 100 may select the type of the MRM in an operation of S401.

Based on the vehicle state information and/or surrounding environment information, the vehicle 100 may perform the MRM, when determining that the ADS is normally operating but the vehicle state is unsuitable for the normal driving conditions, the vehicle may perform the MRM. In addition, even when detecting an abnormal signal for the driver or an emergency stop requested by the driver, the vehicle 100 may perform the MRM.

The vehicle 100 may select the type of the MRM as the straight stop based on the vehicle state information and/or surrounding environment information to perform the MRM. The vehicle 100 may select the type of the MRM as the straight stop, when the lateral control is impossible or the lane or shoulder is detected while the brake control is possible.

The vehicle 100 may predict an MRM allowance space in an operation of S403. The MRM allowance space (also referred to as an MRM buffer zone or an MRM safety zone) may mean a space in which the vehicle 100 can be stationary (e.g., come to a complete stop) by the operation of the MRM.

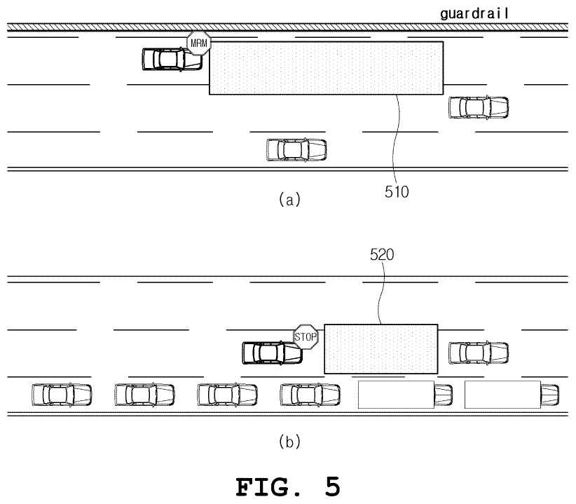

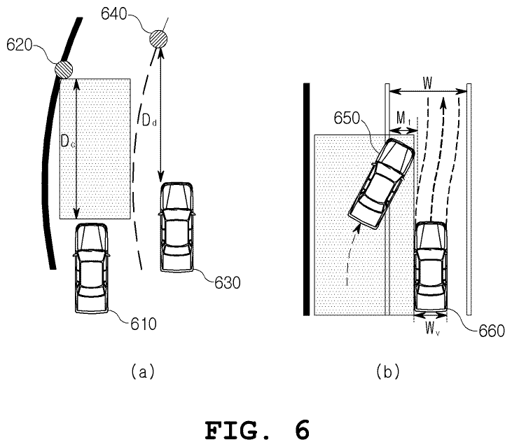

FIGS. 5 and 6 show one example of predicting a minimal risk maneuver allowance space.

Referring to FIG. 5, the vehicle may predict the MRM allowance space 510 and 520 based on integrated information about the guardrail and the position/speed information of the front and surrounding vehicles. In addition, the vehicle 100 may improve the prediction performance of the MRM allowance space by additionally considering positioning information and map information, and may improve the prediction performance of the MRM space by predicting the driving trajectories of the vehicle and the preceding vehicle. The prediction of the MRM allowance space may be performed by using artificial intelligence.

Referring to FIG. 6, the vehicle 100 may predict a longitudinal allowance distance (D_{long}) (also referred to as a longitudinal safety distance or a longitudinal safety margin) and a lateral allowance distance (Dₗₐₜ) (also referred to as a lateral safety distance or a lateral safety margin) to predict the MRM allowance space.

The vehicle 100 may predict a stopping distance (also referred to as a braking distance or a stoppable distance) (D_{S}), a collision risk distance (D_{c}) and a lane departure distance (D_{d}) to predict the longitudinal allowance distance (D_{long}).

The stopping distance (D_{S}) may be predicted based on the current vehicle velocity (v), deceleration for the MRM and free space, as shown in the following mathematical equation 1.

$${D}_{S} = {v}^{2} / 2 α + δ \qquad [ Equation 1 ]$$

When the straight stop is selected as the type of the MRM and there is a guardrail on the left side of the driving lane, such as a vehicle 610 in Lane 1 of FIG. 6, if the lane is curved, there is a point where the driving trajectory of the vehicle 610 and the guardrail intersect, so that a collision risk point 620 may be selected. Additionally, the vehicle 610 may select a collision risk point 620 more precisely by additionally considering the width of the vehicle. The distance within the driving trajectory from the current position to the selected collision risk point 620 may be defined as the collision risk distance (D_{c}).

When selecting the type of the MRM as the straight stop, a vehicle 630 on Lane 2 of FIG. 6 may select a lane departure point 640 by creating a point where the predicted driving trajectory and the lane intersect if the lane is curved. Additionally, the vehicle 630 may select a lane departure point 640 more precisely by additionally considering the width of the vehicle.

Hence, the distance from the current position to the lane departure point 640 may be defined as the lane departure distance (Dd).

The vehicle 100 may define the longitudinal allowance distance (D_{long}) as the minimum value (min(Dₛ, D_{c} and D_{d})) among the stopping distance D_{S}, the collision risk distance D_{c} and the lane departure distance D_{d}.

Referring to (b) of FIG. 6, the lane width W and the maximum intrusion allowance range Mₜ(e.g., 1 m) may be defined.

When stopping based on the MRM, a vehicle 650 may intrude the next lane. For example, even if the straight stop is selected as the type of the MRM, if the steering direction is toward the next lane (e.g., an adjacent lane), there is a possibility of encroaching on the next lane because, for example, if a tire of only one wheel bursts (e.g., gets punctured) and the vehicle moves forward, it will gradually move sideways. In addition, even when the in-lane stop is selected as the type of the MRM, the vehicle may stop in the lane while allowing the intrusion of the next lane.

In this case, a next-lane intrusion allowance range M must be such that a vehicle driving the adjacent lane can avoid the stopped vehicle without changing lanes. That is, the avoid allowance space (also referred to as a minimum safe avoidance width) of the vehicle in the next lane in the lane width W of the next lane must be greater than the width of the vehicle in the next lane plus a safety margin D_{M} (e.g., +0.75 m). Accordingly, the next-lane intrusion allowance range Mₜ may be the smaller of (1) the value obtained by subtracting the width of the vehicle driving in the next lane (Wᵥ) from the width of the next lane W, and (2) the maximum intrusion allowance range (e.g., 1 m). The value as described in (1) may alternatively be the width of the next lane W minus the width of the vehicle driving in the next lane Wᵥ with a safety margin D_{M}, where D_{M}≥0 (e.g., D_{M}=0.75 m). In other words, the value as described in (1) may be represented as Mₜ=W−(Wᵥ+D_{M}).

The lateral allowance distance Dₗₐₜ may be determined based on the position of the vehicle 100 in the lane. When the center of the vehicle 100 is located Xₗₐₜ meters from the left start point of the driving lane, the left lateral allowance distance (Dₐₗ, 1) of the vehicle 100 may be predicted as (Xₗₐₜ−Wᵥ/2+Mₜ). here, Wv represents the width of the vehicle and may be set to one value for each vehicle type (small, medium and large) or one value for all vehicles. Mt is the next-lane intrusion allowance range obtained above.

The vehicle 100 may predict the MRM allowance space based on the longitudinal allowance distance (D_{long}), the left lateral allowance distance (D_{lat,l}) and the right lateral allowance distance (D_{lat,r}).

Referring to FIG. 4 again, the vehicle may be controlled to stop in the predicted allowance space in an operation of S405.

When the longitudinal allowance distance (D_{long}) is determined as the stopping distance Ds, the vehicle 100 may decelerate to a predesignated deceleration velocity. The designated deceleration velocity may be set as a deceleration velocity (e.g., −4 m/s²) for the MRM.

When the longitudinal allowance distance D_{long} is determined as a collision risk distance Dc or lane departure distance Dd, it could be impossible to stop the vehicle in the allowance space in case of decelerating to the designated deceleration velocity. Accordingly, additional vehicle control needs to operate to stop the vehicle in the allowance space.

The vehicle 100 may change the deceleration start point. For example, when the MRM is triggered, the tail lights may be set to flash for 3 seconds and then deceleration may begin. However, to stop in the allowance space, the vehicle 100 may start deceleration at the same time as the MRM is triggered. Additionally, deceleration may start as soon as the MRM is triggered and the calculations for the allowance space are completed

The vehicle 100 may adjust the deceleration velocity to stop in the allowance space. For example, the designated deceleration rate may be set to the deceleration rate for the MRM (e.g., −4 m/s²), but the deceleration rate may be increased to reduce the braking distance by decelerating more quickly.

However, when considering that sudden stops with increased deceleration can increase the risk of collisions with vehicles behind, controlling the deceleration start point may be given higher priority than controlling the deceleration rate. In addition, controlling the deceleration start point and controlling the deceleration/acceleration rate may also be combined and performed simultaneously.

Unless the vehicle 100 stops in the allowance space based on the normal MRM, additional asymmetric braking may be used. For example, if a dangerous behavior is predicted during the MRM (e.g., based on a predicted trajectory of the vehicle 100 satisfying a predetermined condition while performing the MRM), the vehicle 100 may use asymmetric braking to alleviate or eliminate the dangerous behavior situation. For example, the dangerous behavior situation may be a situation in which the vehicle 100 cannot stop in the allowance space only based on the current MRM. When the vehicle 100 performs the straight stop type of the MRM in a situation of driving a curved road, a dangerous behavior situation might occur such as a situation in which the vehicle crosses the lane and collides with a vehicle in another lane or collide with a guardrail. When the lateral control of the vehicle 100 is not performed by the processor entirely or partially (e.g., the amount of the lateral control performed by the vehicle 100 is below a threshold value), a dangerous behavior situation might occur in which the vehicle crosses the lane and collide with a vehicle in another lane due to the lateral control not performed as requested by the processor if the lateral control of the vehicle 100 is not partially or completely operated by the processor.

The vehicle may alleviate or eliminate the dangerous behavior situation by using the asymmetric braking in case of the dangerous behavior situation mentioned above.

The asymmetric braking control is a technology that generally generates a turning moment by applying differentiated braking forces (also referred to as asymmetric braking forces) on the left wheels and right wheels, thereby turning the vehicle. In other words, the braking force being applied to the wheels on the left side of the vehicle may be different from the braking force being applied to the wheels on the right side of the vehicle.

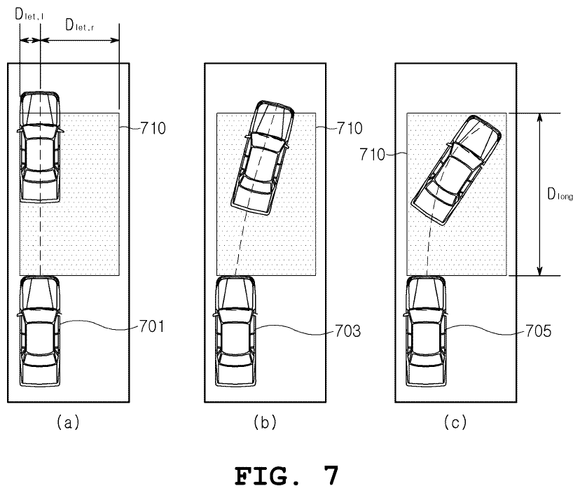

FIG. 7 shows one example of eliminating a dangerous behavior situation based on asymmetric braking and stopping a vehicle in an allowance space.

Referring to FIG. 7, if the asymmetric braking is not performed as shown in (a), there may be a dangerous behavior situation in which the vehicle 100 drives in a straight line, exceeds the longitudinal allowance distance, goes out of the allowance space 710, and reaches the MRC state. That is, when another vehicle or a wall is in the longitudinal allowance distance D_{long}, there may be a dangerous behavior situation in which a vehicle 701 drives in a straight line over the longitudinal allowance distance D_{long} only to reach the MRC state out of the allowance space 710. That is, when another vehicle or a wall is in the longitudinal allowance distance D_{long}, there might be a dangerous behavior situation in which collision occurs. When asymmetric braking is applied as shown in (b), the vehicle 703 turns in the lateral direction and moves in the lateral direction to reach the MRC state. Even in (b), the vehicle cannot reach the MRC state within the allowance space 710 completely, and reach the MRC state over the longitudinal allowance distance D_{long}. However, a dangerous behavior situation such as weakening the collision strength or changing the collided portion may be alleviated. When the asymmetric braking is applied with a greater force in (b) than in (b), the vehicle 705 may drive further in the lateral direction to eliminate the dangerous behavior situation and reach the MRC state within the allowance space 710.

Although not shown in FIG. 7, if too much asymmetric braking is applied, there is a possibility in that the vehicle dangerously turns or moves over the lateral allowance distance (e.g., D_{lat,l} or D_{lat,r}) to the turning direction to escape out of the allowance space 710.

Accordingly, it is necessary to perform an appropriate amount of the asymmetric braking enough to allow the vehicle 100 to stop within the allowance space 710.

For that, the vehicle 100 may predict the driving trajectory for each at least one braking force derivation. The vehicle 100 may determine the braking force deviation based on a determination whether there is a driving trajectory among at least one predicted driving trajectory that allows the vehicle to reach the MRC state within the allowance space 710. The vehicle 100 may predict the driving trajectory by gradually increasing the braking force deviation or by gradually decreasing the braking force deviation. Or, the vehicle 100 may arbitrarily select multiple braking force deviations and predict driving trajectories for the selected multiple braking force deviations, to determine a proper braking force deviation. The vehicle 100 may select the multiple braking force deviations based on the past information.

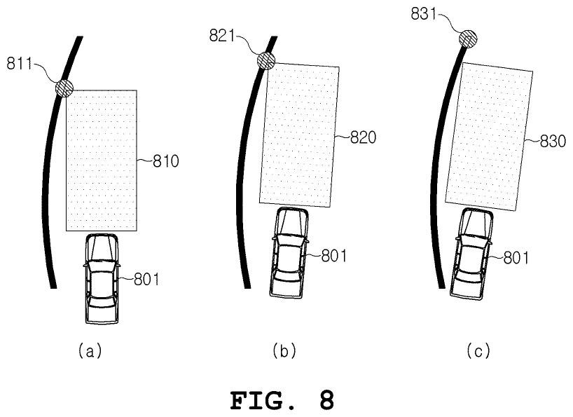

FIG. 8 shows one example of eliminating an allowance space based on asymmetric braking and eliminating a dangerous behavior (e.g., adjusting a trajectory of the vehicle).

Referring to FIG. 8, in case of a curved lane and when a vehicle 800 performs the straight stop as the type of the MRM, as shown in (a), a dangerous behavior situation (e.g., a situation where a predicted trajectory of the vehicle 800 satisfies a predetermined condition while performing the MRM) may be predicted in which the vehicle 800 might collide with a first collision risk point 811 of the guard rail due to a first allowance space 810 that is short to stop the vehicle in the MRC state as shown in (a). when the vehicle 801 performs asymmetric braking in this insulation, the vehicle 801 could turn and then the collision risk point of the vehicle 801 is changed from a first collision risk point 811 to a second collision risk point 821, and the allowance space may be changed from a first allowance space 810 to a second allowance space 820. Due to that, the longitudinal allowance distance may be longer enough to alleviate the dangerous behavior situation.

Additionally, when the vehicle 801 maintains the current asymmetric braking continuously or increases braking force deviations of both wheels, the longitudinal allowance distance may be a third collision risk distance based on a third collision risk point 831. Since the third collision risk distance is longer than the stopping distance of the vehicle 801, the dangerous behavior situation may be eliminated (e.g., the trajectory of the vehicle 801 may be adjusted). Then, the vehicle 801 may terminate the asymmetric braking and control the preset acceleration/deceleration rate for the MRM, to reach the MRC stat within the allowance space.

The vehicle 801 may predict the MRM allowance space in real time while performing the asymmetric braking. If the MRM allowance space is determined by the stopping distance based on the prediction result, the vehicle may determine that the dangerous behavior situation can be eliminated and perform no additional asymmetric braking. Finally, the vehicle can be controlled to stop within the finally determined MRM allowance space.

The vehicle 100 may determine the braking force deviation based on reinforced learning artificial intelligence.

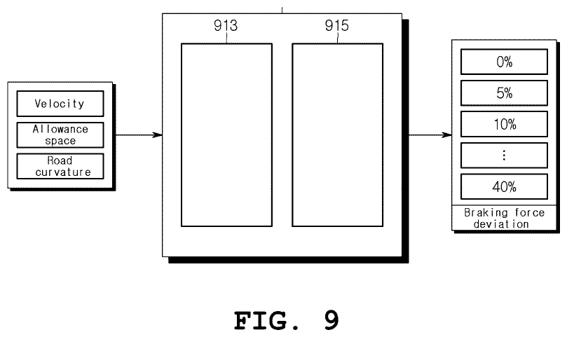

FIG. 9 shows one example of a reinforced learning-based artificial intelligence that determines a braking force deviation of a vehicle.

Referring to FIG. 9, the reinforced learning artificial intelligence 910 may be configured of a convolutional layer 913 and a full connected (FC) layer 915, but the present disclosure is not limited thereto.

The reinforced learning artificial intelligence 910 may be an artificial intelligence that has performed reinforcement learning by using driving trajectory information based on the braking force deviation obtained through simulation or empirical testing. The reinforced learning artificial intelligence 910 may be an artificial intelligence that has performed reinforcement learning by using driving trajectory information based on the initial velocity and braking force of the vehicle. The reinforced learning artificial intelligence 910 may learn to obtain the result shown in (c) of FIG. 7 or (c) of FIG. 8.

As described above, the reinforced learning artificial intelligence 910 may output information about the braking force deviation that the vehicle should perform by inputting information about the vehicle velocity, the determined allowance space and the curvature of the current driving lane. Here, the input of the artificial intelligence 910 may include at least the velocity of the vehicle, the determined allowance space and the curvature information of the current driving lane, but the input is not limited thereto.

The vehicle may be controlled to apply a braking force deviation based on the braking force deviation information output from the artificial intelligence 910.

As described above, the vehicle control method is proposed to predict the allowance space when the straight stop is selected as the type of the MRM to stop the vehicle within the allowance space. The vehicle may perform at least one of the vehicle control operations such as pulling the deceleration start point, increasing the deceleration rate or performing the asymmetric braking so as to stop the vehicle within the allowance space.

The vehicle performing the asymmetric braking may update the allowance space in real time as the vehicle turns due to the asymmetric braking, and then the vehicle may finally stop within the allowance space.

Through such the control, when the vehicle 100 needs the MRM, the vehicle 100 may safely stop within the allowance space.

The functions as described herein may be implemented in hardware, software, firmware, or any combination thereof. If implemented in software, these functions may be stored or transmitted as one or more instructions or codes on a computer-readable medium. The computer-readable media includes both communication media and computer storage media, including any medium that facilitates transfer of a computer program from one place to another. The storage media can be any available media that can be accessed by a computer. By way of example and not limitation, such computer-readable media can include random-access memory (RAM), read-only memory (ROM), electrically erasable programmable read-only memory (EEPROM), compact disc read-only memory (CD-ROM), or other optical disk storage, magnetic disk storage or other magnetic storage devices, or any other medium that can be used to carry or store desired program code in the form of instructions or data structures and that can be accessed by a computer.

When example embodiments are implemented as program code or code segments, it should be recognized that a code segment can represent a procedure, a function, a subprogram, a program, a routine, a subroutine, a module, a software package, a class, or any combination of instructions, data structures, or program statements. A code segment may be coupled to other code segments or hardware circuits by passing and/or receiving information, data, arguments, parameters, or memory contents. information, arguments, parameters, data, etc. may be conveyed, sent, or transmitted using any suitable means, including memory sharing, message passing, token passing, network transmission, etc. Additionally, in some aspects the steps and/or operations of a method or algorithm may reside as one or any combination or set of codes and/or instructions on a machine-readable medium and/or a computer-readable medium that may be incorporated into a computer program product.

In a software implementation, the techniques described herein may be implemented as modules (e.g., procedures, functions, etc.) that perform the functions described herein. The memory unit may be implemented within the processor or external to the processor, in which case the memory unit may be communicatively coupled to the processor by various means, as is well known.

In a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions described herein, or a combination thereof.

A vehicle may include at least one sensor, a controller configured to control an operation of the vehicle and a processor electrically connected to the at least one sensor and the controller. The processor may be configured to monitor vehicle state information and/or surrounding environment information, to determine whether an autonomous driving is possible based on the state information and/or surrounding environment information, to perform a minimal risk maneuver (MRM) when the autonomous driving is not possible, and to perform the MRM by additionally using asymmetric braking that applies a braking force deviation between left wheels and right wheels of the vehicle, when a dangerous behavior is predicted even with the MRM.

The processor may be further configured to predict, as the dangerous behavior, a situation in which a straight stop is selected as a type of the MRM and the vehicle is driving on a curved road.

The processor may be configured to predict a state in which the straight stop is selected as the type of the MRM due to lateral control that is performed partially or not entirely and the vehicle is driving a curved road, as the dangerous behavior.

The processor may be configured to predict, as the dangerous behavior, a situation in which lane departure, guard rail collision or collision with another vehicle is predicted.

The processor may be further configured to set an MRM allowance space by using a longitudinal allowance distance and a lateral allowance distance, when the straight stop is selected as the type of the MRM, to predict a stopping distance, a collision risk distance and/or a lane departure distance and determine the shortest distance as the longitudinal allowance distance among the predicted stopping distance, collision risk distance and lane departure distance, and to determine that the lateral allowance distance is a smaller value between a value calculated by (next-lane width (W)−the width of another vehicle driving in the next lane (Wᵥ−0.75 m) and a maximum intrusion allowance range.

The processor may be configured to predict that the situation is the dangerous risk behavior when the longitudinal allowance distance is shorter than the stopping distance.

When the dangerous behavior is predicted, the processor may be further configured to predict at least one driving trajectory based on at least one braking force deviation, and to determine, from among the at least one braking force deviation, a braking force deviation to be applied to the vehicle when the predicted driving trajectory based on the baking force deviation shows the vehicle to stop within the MRM allowance space.

The processor may be further configured to update the MRM allowance space as the vehicle turns due to the asymmetric braking, and to re-determine the braking force deviation based on the updated MRM allowance space.

The processor may be further configured to determine a braking force deviation to be applied to the vehicle by using a reinforced learning artificial intelligence based on driving trajectory information due to a braking force deviation obtained by simulation or actual tests.

The processor may be further configured to provide, as input for the determination of the artificial intelligence, information about the velocity of the vehicle, the preset MRM allowance space and information about the curvature of a current driving lane.

A method of operating a vehicle may include monitoring vehicle state information and/or surrounding environment information, determining whether autonomous driving is possible based on the vehicle state information and/or surrounding environment information, performing MRM when the autonomous driving is not possible and predicting a dangerous behavior.

The performing the MRM may include performing the MRM by additionally using asymmetric braking that applies a braking force deviation between left wheels and right wheels of the vehicle, when the dangerous behavior is predicted.

The predicting the dangerous behavior may include predicting, as the dangerous behavior, a situation in which a straight stop is selected as a type of the MRM and the vehicle is driving on a curved road.

The predicting the dangerous behavior may include predicting, as the dangerous behavior, a situation in which the straight stop is selected as the type of the MRM due to lateral control not being performed partially or entirely and the vehicle is driving a curved road.

The predicting the dangerous behavior may include predicting, as the dangerous behavior, a situation in which lane departure, guard rail collision or collision with another vehicle is predicted.

The determining the type of the MRM may selecting the straight stop, the performing the MRM may further include setting an MRM allowance space. The setting the MRM allowance space may include predicting a stopping distance, a collision risk distance and/or a lane departure distance and determine the shortest distance as the longitudinal allowance distance among the predicted stopping distance, collision risk distance and lane departure distance, determining, as the lateral allowance distance, a smaller value between a value calculated by (next-lane width (W)−the width of another vehicle driving in the next lane (Wᵥ−0.75 m) and a maximum intrusion allowance range and setting the MRM allowance space based on the longitudinal allowance distance and the lateral allowance distance.
the predicting the dangerous behavior may further include predicting, as the dangerous behavior, a situation in which the longitudinal allowance distance is shorter than the stopping distance.

When the dangerous behavior is predicted, the performing the MRM by additionally using the asymmetric braking may further include predicting at least one driving trajectory based on at least one braking force deviation and determining, from among the at least one braking force deviation, a braking force derivation to be applied to the vehicle when the predicted driving trajectory based on the braking force deviation shows the vehicle to stop within the MRM allowance space.

The performing the MRM by additionally using the asymmetric braking, when the dangerous behavior is predicted, may further include updating the MRM allowance space as the vehicle turns due to the asymmetric braking and re-determining the braking force deviation based on the updated MRM allowance space.

The determining the braking force deviation to be applied to the vehicle may include determining the braking force deviation to be applied to the vehicle by using a reinforced learning artificial intelligence based on driving trajectory information due to a braking force deviation obtained by simulation or actual tests.

The determining the braking force deviation to be applied to the vehicle may further include providing, as input for the determination of the artificial intelligence, information about the velocity of the vehicle, the preset MRM allowance space and information about the curvature of a current driving lane.

The foregoing includes examples of one or more example embodiments. Of course, it is not possible to describe every possible combination of components or methods for purposes of describing the example embodiments described above, but those skilled in the art will recognize that many additional combinations and permutations of the various embodiments are possible. Accordingly, the described example embodiments are intended to include all alternatives, modifications and variations that fall within the true spirit and scope of the appended claims. Furthermore, to the extent that the term “comprises” is used in the detailed description or claims, such term is intended to be included in a similar manner as “configured of” as the term “consisting of” is to be interpreted when used as a transitional word in the claims.

As used herein, the term “infer” or “inference” generally refers to the process of making judgments or inferences about the state of a system, environment, and/or user from a set of observations captured by events and/or data. Inference can be used to identify specific situations or actions, or to generate probability distributions over states, for example. Inference can be probabilistic, that is, it can be the computation of probability distributions over relevant states based on an examination of data and events. This inference allows us to infer new events or behaviors from a set of observed events and/or stored event data, whether the events are closely correlated in time, and whether the events and data come from one or more event and data sources.

Furthermore, as used in this application, the terms “component,” “module,” “system,” and the like include, but are not limited to, computer-related entities such as hardware, firmware, a combination of hardware and software, software, or software in execution. For example, a component may be, but is not limited to, a process running on a processor, a processor, an object, an executable thread of execution, a program, and/or a computer. For example, both an application running on a computing device and the computing device can be a component. One or more components can reside within a process and/or thread of execution, and a component can be centralized on one computer and/or distributed between two or more computers. Additionally, these components can be executed from various computer-readable media storing various data structures. Components may communicate by local and/or remote processes, such as by signals having one or more data packets (e.g., data from a local system, from other components in a distributed system, and/or from a component interacting with other systems via a network such as the Internet).

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

1. A vehicle comprising:
at least one sensor configured to detect a surrounding environment of the vehicle;
a controller configured to control an operation of the vehicle; and
a processor coupled to the at least one sensor and the controller;
wherein the processor is configured to:
identify vehicle state information of the vehicle;
identify, based on the detected surrounding environment, surrounding environment information associated with the vehicle;
determine, based on at least one of the vehicle state information or the surrounding environment information, whether autonomous driving is possible for the vehicle; and
perform, based on the autonomous driving not being possible, a minimal risk maneuver (MRM),
wherein the performing of the MRM comprises applying, based on a predicted trajectory of the vehicle satisfying a predetermined condition while performing the MRM, asymmetric braking forces to left wheels of the vehicle and right wheels of the vehicle.

2. The vehicle of claim 1, wherein the processor is further configured to:
determine that the predicted trajectory of the vehicle satisfies the predetermined condition while performing the MRM, based on the MRM comprising performance of a straight stop as a type of the MRM and based on the vehicle driving on a curved road.

3. The vehicle of claim 1, wherein the processor is further configured to:
determine that the predicted trajectory of the vehicle satisfies the predetermined condition while performing the MRM, based on the MRM comprising performance of a stop with an amount of lateral control below a threshold value and based on the vehicle driving on a curved road.

4. The vehicle of claim 1, wherein the processor is further configured to:
determine that the predicted trajectory of the vehicle satisfies the predetermined condition while performing the MRM, based on the predicted trajectory indicating at least one of: a predicted lane departure, a predicted collision with a guard rail, or a predicted collision with another vehicle.

5. The vehicle of claim 1, wherein the processor is further configured to:
determine a longitudinal safety distance by selecting a least value of: a stopping distance, a collision risk distance, and a lane departure distance;
determine a lateral safety distance by selecting a lesser value of:
a width of an adjacent lane minus a width of another vehicle driving in the adjacent lane, and
a maximum intrusion allowance range; and
determine, based on the MRM comprising performance of a straight stop, an MRM buffer zone according to the longitudinal safety distance and the lateral safety distance.

6. The vehicle of claim 5, wherein the processor is further configured to:
determine that the predicted trajectory of the vehicle satisfies the predetermined condition while performing the MRM, based on the longitudinal safety distance being less than the stopping distance.

7. The vehicle of claim 5, wherein the processor is configured to apply the asymmetric braking forces by:
determining at least one predicted trajectory based on at least one differential braking force; and
determining, from among the at least one differential braking force, a differential braking force that allows the vehicle to stop within the MRM buffer zone.

8. The vehicle of claim 7, wherein the processor is further configured to:
update, based on the vehicle turning due to the differential braking force, the MRM buffer zone; and
determine, based on the updated MRM buffer zone, an updated differential braking force.

9. The vehicle of claim 7, wherein the processor is further configured to:
determine the differential braking force by using a reinforced learning artificial intelligence based on driving trajectory information, wherein the driving trajectory information indicates differential braking forces obtained by a simulation or an empirical test.

10. The vehicle of claim 9, wherein the processor is further configured to:
provide, as an input for training the reinforced learning artificial intelligence, information about a velocity of the vehicle, a predetermined MRM buffer zone, and information about a curvature of a current driving lane.

11. A method performed by an apparatus of a vehicle, the method comprising:
identifying vehicle state information of the vehicle;
identifying, based on a surrounding environment of the vehicle detected by at least one sensor, surrounding environment information associated with the vehicle;
determining, based on at least one of the vehicle state information or the surrounding environment information, whether autonomous driving is possible for the vehicle; and
performing, based on the autonomous driving not being possible, a minimal risk maneuver (MRM),
wherein the performing of the MRM comprises applying, based on a predicted trajectory of the vehicle satisfying a predetermined condition while performing the MRM, asymmetric braking forces to left wheels of the vehicle and right wheels of the vehicle.

12. The method of claim 11, further comprising:
determining that the predicted trajectory of the vehicle satisfies the predetermined condition while performing the MRM, based on the MRM comprising performance of a straight stop as a type of the MRM and based on the vehicle driving on a curved road.

13. The method of claim 11, further comprising:
determining that the predicted trajectory of the vehicle satisfies the predetermined condition while performing the MRM, based on the MRM comprising performance of a stop with an amount of lateral control below a threshold value and based on the vehicle driving on a curved road.

14. The method of claim 11, further comprising:
determining that the predicted trajectory of the vehicle satisfies the predetermined condition while performing the MRM, based on the predicted trajectory indicating at least one of: a predicted lane departure, a predicted collision with a guard rail, or a predicted collision with another vehicle.

15. The method of claim 11, further comprising:
determining a longitudinal safety distance by selecting a least value of: a stopping distance, a collision risk distance, and a lane departure distance;
determining a lateral safety distance by selecting a lesser value of:
a width of an adjacent lane minus a width of another vehicle driving in the adjacent lane, and
a maximum intrusion allowance range; and
determining, based on the MRM comprising performance of a straight stop, an MRM buffer zone according to the longitudinal safety distance and the lateral safety distance.

16. The method of claim 15, further comprising:
determining that the predicted trajectory of the vehicle satisfies the predetermined condition while performing the MRM, based on the longitudinal safety distance being less than the stopping distance.

17. The method of claim 15, wherein the applying of the asymmetric braking forces comprises:
determining at least one predicted trajectory based on at least one differential braking force; and
determining, from among the at least one differential braking force, a differential braking force that allows the vehicle to stop within the MRM buffer zone.

18. The method of claim 17, further comprising:
updating, based on the vehicle turning due to the differential braking force, the MRM buffer zone; and
determining, based on the updated MRM buffer zone, an updated differential braking force.

19. The method of claim 17, further comprising:
determining the differential braking force by using a reinforced learning artificial intelligence based on driving trajectory information, wherein the driving trajectory information indicates differential braking forces obtained by a simulation or an empirical test.

20. The method of claim 19, further comprising:
providing, as an input for training the reinforced learning artificial intelligence, information about a velocity of the vehicle, a predetermined MRM buffer zone, and information about a curvature of a current driving lane.
